(19) United States
(12) Patent Application Publication
(10) Pub. No.: US 2015/0109148 A1
(43) Pub. Date: Apr. 23, 2015

(54) Pedestrian Warning System

(71) Applicant: Elwha LLC, Bellevue, WA (US)

(72) Inventors: Jesse R. Cheatham, III, Seattle, WA (US); William D. Duncan, Kirkland, WA (US); Roderick A. Hyde, Redmond, WA (US); Nathan P. Myhrvold, Medina, WA (US); Lowell L. Wood, JR., Bellevue, WA (US)

(73) Assignee: Elwha LLC

(21) Appl. No.: 14/057,732

(22) Filed: Oct. 18, 2013

(51) Int. Cl. G08G 1/005

(52) U.S. Cl. CPC G08G 1/005
USPC 340/944

(57) ABSTRACT

A pedestrian warning system detects vehicle-mounted radar or lidar systems (generally, but not necessarily, provided for avoiding collisions with other vehicles) and alerts the pedestrian of a potential collision.

If an Application Data Sheet (ADS) has been filed on the filing date of this application, it is incorporated by reference herein. Any applications claimed on the ADS for priority under 35 U.S.C. §§119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

### CROSS-REFERENCE TO RELATED APPLICATIONS

The present application claims the benefit of the earliest available effective filing date(s) from the following listed application(s) (the “Priority Applications”), if any, listed below (e.g., claims earliest available priority dates for other than provisional patent applications or claims benefits under 35 USC §119(e) for provisional patent applications, for any and all parent, grandparent, great-grandparent, etc. applications of the Priority Application(s)). In addition, the present application is related to the “Related Applications,” if any, listed below.

### PRIORITY APPLICATIONS

None.

### RELATED APPLICATIONS

U.S. patent application Ser. No. 13/950,719, entitled WEARABLE RADAR REFLECTORS, naming TOM DRISCOLL, RODERICK A. HYDE, JORDIN T. KARE, DAVID R. SMITH, CLARENCE T. TEGREENE as inventors, filed 25 JULY 2013 with attorney docket no. 0513-035-001-000000, is related to the present application.

U.S. patent application Ser. No. 14/011,275, entitled WEARABLE RADAR REFLECTORS, naming TOM DRISCOLL, RODERICK A. HYDE, JORDIN T. KARE, DAVID R. SMITH, CLARENCE T. TEGREENE as inventors, filed 27 Aug. 2013 with attorney docket no. 0513-035-001-CIP001, is related to the present application.

If the listings of applications provided above are inconsistent with the listings provided via an ADS, it is the intent of the Applicant to claim priority to each application that appears in the Priority Applications section of the ADS and to each application that appears in the Priority Applications section of this application.

All subject matter of the Priority Applications and the Related Applications and of any and all parent, grandparent, great-grandparent, etc. applications of the Priority Applications and the Related Applications, including any priority claims, is incorporated herein by reference to the extent such subject matter is not inconsistent herewith.

### SUMMARY

In one aspect, a pedestrian warning device includes a radar detector configured to be worn or carried by a pedestrian and to detect radar signals coming from a vehicle, and an alarm configured to warn the pedestrian of the vehicle. The alarm may be audible (e.g., a prerecorded or synthesized voice), visual, or haptic. The alarm may indicate a location or other information about the vehicle (e.g., direction, proximity, range, time-to-impact, color, make, or model), and may include a command for the pedestrian (e.g., freeze, slow down, speed up, move in a particular direction, brake). The device may include a decision unit configure to determine whether to sound the alarm, which may be configured to decide whether to sound the alarm or to customize the alarm based at least in part on the pedestrian's position, the pedestrian's orientation, the pedestrian's movement direction, the pedestrian's speed, the pedestrian's companions, the pedestrian's movement history, the vehicle's range, the vehicle's direction, the vehicle's speed, the vehicle's time to impact, or the position of a second vehicle. The device may include transmission means configured to communicate to the vehicle, which may include a radar transmitter, a lidar transmitter, a reflector, a retroreflector (e.g., a modulated retroreflector), and may be configured to communicate detection of vehicle, issued alert, the pedestrian's position, the pedestrian's speed, or pedestrian's response to alert. The device may include a recording unit that may be configured to record the signal emanating from the vehicle, the time of the signal, the location of the vehicle, the location of the pedestrian, the speed of the vehicle, the direction of the vehicle, the time-to-impact, the speed of the pedestrian, the position of the pedestrian, any alarms issued, or any reaction of the pedestrian to an issued alarm. The device may include control means configured to issue a control directive (e.g., a command to brake, a command to stop, a command to change direction, a command to change speed, and a command to activate a driver alert) to a pedestrian vehicle under control of the pedestrian (e.g., a bicycle, an electric-assisted bicycle, a skateboard, a motorized skateboard, a scooter, a motorized skateboard, a motorized scooter, a personal transporter, a wheelchair, or a powered wheelchair). The device may be a cellular telephone. The device may be configured to determine a characteristic of the detected radar signal (e.g., direction, frequency, Doppler shifts, amplitude, waveform, or informational modulation of the radar signal). The device may include an accelerometer (in which case it may have a control system configured to use data from the accelerometer to determine a response of the pedestrian to a warning), a GPS receiver, or a digital memory configured to store digital mapping data.

In another aspect, a pedestrian warning device includes a lidar detector configured to be worn or carried by a pedestrian and to detect lidar signals coming from a vehicle, and an alarm configured to warn the pedestrian of the vehicle. The alarm may be audible (e.g., a prerecorded or synthesized voice), visual, or haptic. The alarm may include a command for the pedestrian (e.g., freeze, slow down, speed up, move in a particular direction, brake). The device may include a decision unit configure to determine whether to sound the alarm, which may be configured to decide whether to sound the alarm or to customize the alarm based at least in part on the pedestrian's position, the pedestrian's orientation, the pedestrian's movement direction, the pedestrian's speed, the pedestrian's companions, the pedestrian's movement history, the vehicle's range, the vehicle's direction, the vehicle's speed, the vehicle's time to impact, or the position of a second vehicle. The device may include transmission means configured to communicate to the vehicle. The device may include a recording unit that may be configured to record the signal emanating from the vehicle, the time of the signal, the location of the vehicle, the location of the pedestrian, the speed of the vehicle, the direction of the vehicle, the time-to-impact, the speed of the pedestrian, the position of the pedestrian, any alarms issued, or any reaction of the pedestrian to an issued alarm. The device may include control means configured to issue a control directive to a pedestrian vehicle under control of the pedestrian. The device may include an accelerometer (in which case it may have a control system configured to use data from the accelerometer to determine a response of the pedestrian to a warning), a GPS receiver, or a digital memory configured to store digital mapping data.

In another aspect, a method of warning a pedestrian of a vehicle includes receiving a radar signal from the vehicle at a radar detector configured to be worn or carried by the pedestrian, and alerting the pedestrian with an alarm. Alerting the pedestrian may include alerting the pedestrian with a sound (e.g., a prerecorded or synthesized voice), visually, or haptically. Alerting the pedestrian may include issuing a command to the pedestrian (e.g., freeze, slow down, speed up, move in a particular direction, brake), or giving the pedestrian information about the vehicle (e.g., direction, proximity, range, time-to-impact, color, make, or model). Alerting the pedestrian may include alerting the pedestrian (e.g., by issuing an alarm) in response to of the pedestrian's position, the pedestrian's orientation, the pedestrian's movement direction, the pedestrian's speed, the pedestrian's companions, the pedestrian's movement history, the vehicle's range, the vehicle's direction, the vehicle's speed, the vehicle's time to impact, or the position of a second vehicle. The method may further include transmitting a response signal back to the vehicle (e.g., a radar signal, a lidar signal, a reflected radar signal, a retroreflected radar signal, or a modulated retroreflected radar signal), which may include reporting of detection of the vehicle, issued alert, the pedestrian's position, the pedestrian's speed, or pedestrian's response to alert. The method may further include recording the signal emanating from the vehicle, the time of the signal, the location of the vehicle, the location of the pedestrian, the speed of the vehicle, the direction of the vehicle, the time-to-impact, the speed of the pedestrian, the position of the pedestrian, any alerts issued, or any reaction of the pedestrian to an issued alert, or it may include transmitting a control directive (e.g., a command to brake, a command to stop, a command to change direction, a command to change speed, and a command to activate a driver alert) to a pedestrian vehicle under control of the pedestrian (e.g., a bicycle, an electric-assisted bicycle, a skateboard, a motorized skateboard, a scooter, a motorized skateboard, a motorized scooter, a personal transporter, a wheelchair, or a powered wheelchair). The method may further include determining a characteristic of the detected radar signal (e.g., direction, frequency, Doppler shifts, amplitude, waveform, or informational modulation), and may include using an accelerometer to determine a response of the pedestrian to the alarm.

In another aspect, a method of warning a pedestrian of a vehicle includes receiving a lidar signal from the vehicle at a lidar detector configured to be worn or carried by the pedestrian, and alerting the pedestrian with an alarm. Alerting the pedestrian may include alerting the pedestrian with a sound (e.g., a prerecorded or synthesized voice), visually, or haptically. Alerting the pedestrian may include issuing a command to the pedestrian (e.g., freeze, slow down, speed up, move in a particular direction, brake), or giving the pedestrian information about the vehicle (e.g., direction, proximity, range, time-to-impact, color, make, or model). Alerting the pedestrian may include alerting the pedestrian (e.g., by issuing an alarm) in response to of the pedestrian's position, the pedestrian's orientation, the pedestrian's movement direction, the pedestrian's speed, the pedestrian's companions, the pedestrian's movement history, the vehicle's range, the vehicle's direction, the vehicle's speed, the vehicle's time to impact, or the position of a second vehicle. The method may further include recording the signal emanating from the vehicle, the time of the signal, the location of the vehicle, the location of the pedestrian, the speed of the vehicle, the direction of the vehicle, the time-to-impact, the speed of the pedestrian, the position of the pedestrian, any alerts issued, or any reaction of the pedestrian to an issued alert, or it may include transmitting a control directive to a pedestrian vehicle under control of the pedestrian. The method may further include using an accelerometer to determine a response of the pedestrian to the alarm.

In another aspect, a pedestrian warning device includes a vehicle detector configured to be worn or carried by a pedestrian and to detect signals emanating from a vehicle, and an alarm configured to warn the pedestrian of the vehicle. The vehicle detector may include a wide-angle camera. The device may include a transmitter configured to transmit information about the pedestrian to the vehicle. The transmitter may be passive (e.g., a retroreflector) or powered (e.g., by a battery or by the pedestrian).

In another aspect, a pedestrian warning system includes a beacon radar transmitter configured to transmit a radar signal including vehicle information (e.g., speed, direction, position, maximum speed, braking capabilities, turning capabilities, make, model, color, or driver identifying information), wherein the transmitted signal may be received by a pedestrian to communicate vehicle information to the pedestrian.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1 is a schematic of a pedestrian warning system.

FIG. 2 is a flow chart of a decision process for warning a pedestrian.

FIG. 3 shows a cellular telephone running an app for warning a pedestrian.

FIG. 4 is a schematic of a vehicle-mounted modulated radar transmitter.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

“Pedestrian,” as that term is used herein, includes a human or pet that is not currently in a vehicle, or is using a “pedestrian vehicle” typically permitted on a sidewalk, such as a bicycle, wagon, skateboard, scooter, wheelchair (including motorized wheelchairs), or personal transport such as a SEGWAY™. Pedestrians may include adults, children, dogs, cats, livestock, or other animals. “Demographics” of a pedestrian may include species, age, sex, physical capabilities (or capabilities of a pedestrian vehicle in use), or other relevant information about the pedestrian. “Identifying information” of a pedestrian may include information such as name, address, guardian, next-of-kin, owner, or the like.

“Garment,” as that term is used herein, includes clothing, apparel, or jewelry such as but not limited to shirts, coats, pants, shoes, hats, collars, bracelets, earrings, belts, or backpacks, and also objects designed to be carried by pedestrians, such as but not limited to briefcases, purses, suitcases, keyfobs, cellphones, or tablets.

“Retroreflector,” as that term is used herein, includes “passive” retroreflectors that reflect a signal back in the direction from which it came (e.g., a corner cube or a Van Atta array), and also “active” retroreflectors which boost or filter a received signal or send a modulated response signal back in the direction from which a signal was received (e.g., a Van Atta array including switches for modulation of the retroreflection, as described in Thornton, et al., “Modulating retro-reflector as a passive radar transponder,” Elect. Lett. (September 1998) 34(19):1880-1881, which is incorporated by reference herein).

Cars and trucks are increasingly being outfitted with technological systems for collision avoidance. In particular, cars and trucks are beginning to include radar (or lidar) systems, primarily for detecting other vehicles for collision avoidance or for convoying. Vehicles may also emit signals when using radar detectors or similar devices. Signals emitted by such vehicles may be detected by pedestrians and used to warn them of oncoming vehicles. Pedestrians, especially children and pets, may panic at the sight of an oncoming vehicle and may use counterproductive avoidance strategies like trying to outrun a car. A system that uses ingrained reflexes, especially when issued before the oncoming vehicle is seen (e.g., in a parent's voice), may produce more productive behavior.

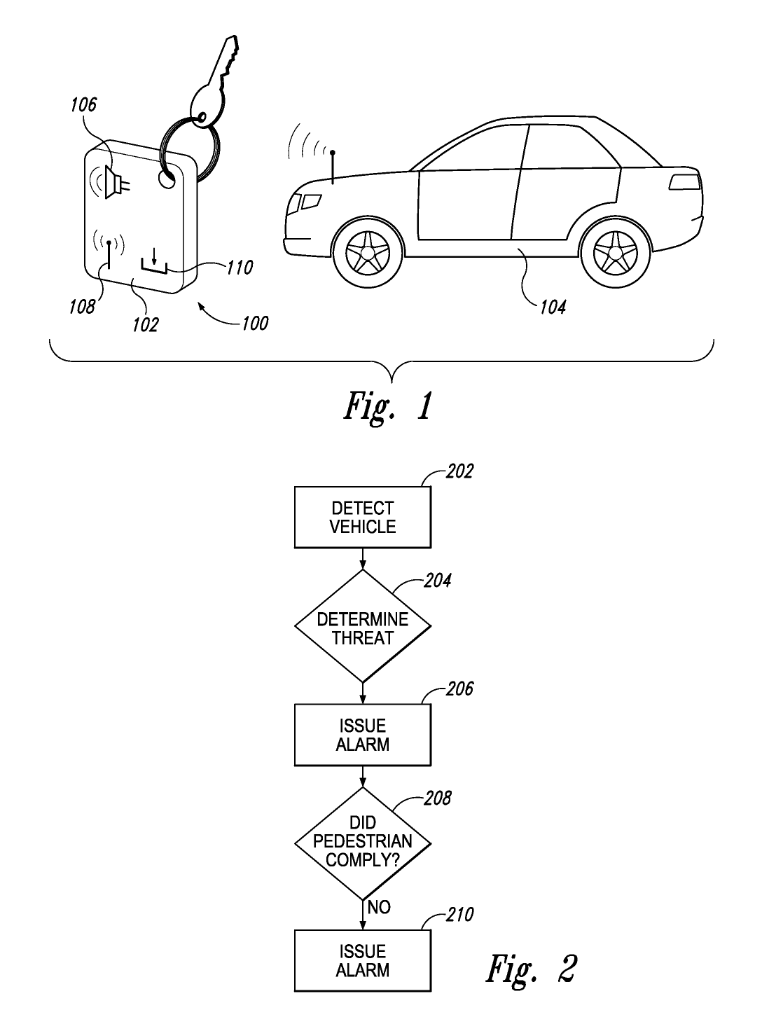

FIG. 1 is a schematic of a pedestrian warning system 100. System 100 is described in the context of radar signals; however, any of the functionality described below may also be applied to lidar signals. Receiver 102 is configured to be worn or carried by a pedestrian. For example, receiver 102 may be incorporated into a garment, or as shown in FIG. 1, it may be attached to a key ring intended to be carried in a pocket. Receiver 102 is configured to detect radar signals in a band used for collision avoidance (e.g., about 1 to about 300 GHz or about 70 to about 85 GHz). When vehicle 104 approaches a pedestrian closely enough for it to receive such a radar signal, the approach triggers alarm 106. The alarm may be audible (e.g., a buzzer or a recorded or synthesized voice), visual (e.g., a light, a text warning, or a video), tactile/haptic (e.g., vibration or mild electric shock), a combination of these, or any other indication that will be perceived by the pedestrian. It may simply convey a general alert, or may include more specific information or instructions (e.g., “Miata at 2 o'clock” or “freeze!”). An alarm may be repeated, or another alarm modality may be chosen, based on the pedestrian's response to the first alarm. For example, alarm 106 may beep quietly to let the pedestrian know that there is a radar-equipped vehicle nearby, but may issue a voice directive or a siren when receiver 102 detects that the pedestrian is in imminent danger.

Receiver 102 may be any device capable of detecting a radar signal issuing from a vehicle, but the steerable antenna described in U.S. patent application Ser. No. 13/317,338, filed Oct. 14, 2011, attorney docket 0209-011-001-000000, entitled “Surface Scattering Antennas,” published as U.S. Pat. Pub. No. 2012/0194399, which is incorporated by reference herein, may be particularly effective for a user-portable device. The steerable antenna scans the local space, thus providing direction information for the pedestrian, which may more difficult to obtain using a low-gain antenna. Other traditional or metamaterial-based lenses or other components may also be used to discriminate direction, such as a Rotman lens (described in U.S. Pat. Pub. No. 2012/0286897, incorporated by reference herein) or a Luneburg lens (described in 2011/0116170, incorporated by reference herein). In other embodiments, low-gain antennas may simply provide the information that there is an emitter in the vicinity without providing directional information.

In some embodiments, system 100 may also include a transmitter 108 which transmits information about the pedestrian back to vehicle 104. Transmitter 108 may be an active (powered) transmitter, or it may be a powered or unpowered reflector or retroreflector, such as those described in U.S. patent application Ser. No. 13/950,719, entitled WEARABLE RADAR REFLECTORS and filed Jul. 25, 2013, and U.S. patent application Ser. No. 14/011,275, entitled WEARABLE RADAR REFLECTORS and filed Aug. 27, 2013, each of which is incorporated by reference herein. The transmitter may simply provide the basic information that there is “something” that the vehicle's collision avoidance radar should avoid at the transmitter location, or more detailed data about the pedestrian's position, demographics, and/or characteristics, as more fully described in the above-referenced patent applications.

In some embodiments, system 100 may also include (via software or hardware) a decision unit (not pictured in FIG. 1; see step 204 in FIG. 2 below) configured to determine whether to sound the alarm. Instead of simply alerting the pedestrian whenever a radar-equipped vehicle approaches, system 100 may in such embodiments take a more nuanced approach to warnings, thereby potentially avoiding alarm fatigue or embarrassment of the pedestrian. For example, the decision unit may be configured to warn the pedestrian only when the pedestrian appears to be traveling in a direction or at a speed such that s/he will be expected to be crossing the road at the same time as the vehicle. This information may be determined, for example, via an accelerometer, digital map, or GPS system (not shown) integrated into system 100. These components may also be useful to identify whether and how the pedestrian responds to the alarm. Other data that the decision unit may take into account include the pedestrian's location (e.g., in a yard vs. on a sidewalk), whether a pedestrian pet is leashed or off leash, the length of the leash, whether a pedestrian child is accompanied by parents, accompanied by friends, or alone, whether the pedestrian is looking in the direction of the car or not, whether the pedestrian appears to be distracted (e.g., by texting; see discussion of smartphones below), the likelihood that the pedestrian will heed a warning (e.g., based on history with a particular pedestrian), the native language of the pedestrian, and the initial response of the pedestrian (which may be used to determine whether to repeat or to escalate a warning, either during the same encounter or during a subsequent one). Many of these decisions may be based upon explicitly selected user preferences; others may be “learned” by experience with a particular pedestrian.

In some embodiments, system 100 may be configured to determine a characteristic of the detected signal, such as direction, frequency, Doppler shifts, amplitude, waveform, or informational modulation of the radar signal. Any of these may be used to infer information about vehicle 104 and the likelihood of collision with the pedestrian.

System 100 may further include a recording unit 110, which may be used to record the time, signals received, alarms issued, vehicle or pedestrian location, signals sent, pedestrian responses, or other relevant data. Such signal may be used, for example, for forensic reconstruction of an accident, or simply to report back to the pedestrian's guardian about pedestrian's responses. For example, if a child correctly freezes when the system 100 issues a “freeze” command, his parents may wish to reward this behavior. In some embodiments, system 100 may include the ability to “test” a child's responses even when there are no vehicles present. System 100 may also be used to record information about vehicles in a neighborhood; if the pedestrian encounters a large number of fast-moving vehicles, his guardians may restrict his future access or lobby for traffic controls. Data may be stored locally in receiver 102 or elsewhere in system 100, or it may be transmitted to another location for storage, for example using transmitter 108.

In embodiments where the pedestrian is using a pedestrian vehicle, system 100 may further include the capability to issue control directives to the vehicle, either via transmitter 108 or another wireless or wired transmission system. For example, instead or in addition to telling a pedestrian to “freeze,” the system may also issue a command to a wheelchair or a bicycle to brake, speed up, or turn. In some embodiments, these directives may be user-overridable, while in others, system 100 may take non-overridable control of the pedestrian vehicle. In some embodiments, system 100 will attempt to alert the pedestrian before issuing commands to his vehicle; in other embodiments, the first alert may be a vehicle command such as engaging the brakes.

FIG. 2 illustrates a decision process for the system illustrated in FIG. 1. Receiver 102 detects 202 a radar signal emanating from a radar-equipped vehicle 104. System 100 determines 204 whether the vehicle is a potential threat to the pedestrian wearing or carrying system 100. If the vehicle is a potential threat, alarm 106 is triggered 206, for example to issue a warning beep. System 100 then monitors 208 the response of the pedestrian, for example using an accelerometer. If the pedestrian ignores alarm 106, it issues 210 a “louder” alarm. This second alarm may not be literally louder, but only more likely to capture the attention of the pedestrian, such as a recording of a parent telling the pedestrian to pay attention or to freeze. Since the pedestrian may not have already become frightened by the presence of the vehicle, such voice recordings may be particularly effective in inducing quick, unthinking compliance. Alternatively, the “louder” alarm may be issuing a control directive to a pedestrian vehicle as described above. Information that may be used to determine the threat level of a vehicle may include the pedestrian's position, the pedestrian's orientation, the pedestrian's movement direction, the pedestrian's speed, the pedestrian's companions, the pedestrian's movement history, the vehicle's range, the vehicle's direction, the vehicle's speed, the vehicle's time to impact, and the position of a second vehicle.

In another embodiment, when system 100 includes transmitter 108 that is capable of communicating with the radar-emitting vehicle 104, some or all of the functions described above in connection with the decision unit may instead be performed by the vehicle. For example, when a vehicle detects system 100, it may “tell” the system what actions it intends to take. This information can be used to decide what alarm (if any) to issue. Or the vehicle may realize that system 100 has detected its side-facing or rear-facing radar, and in fact there is no danger of collision, and may communicate that fact so that system 100 does not alert the pedestrian. The vehicle may perform some or all of the collision-avoidance or collision-mitigation maneuvers, and may deploy collision-mitigation devices such as external airbags or extendable bumpers if so directed by system 100 or if its own onboard systems indicate that they are warranted. Even if vehicle 104 does not take over any of the decision steps for determining how or whether to warn the pedestrian, transmitter 108 may still communicate information such as detection of vehicle, issued alert, the pedestrian's position, the pedestrian's speed, or pedestrian's response to alert.

In some embodiments, rather than detecting radar or lidar signals, system 100 may be configured to detect vehicles by any other transmission from the vehicle 104. For example, system 100 may use a wide-angle camera to image vehicles, then one or a series of alarms 106 as described above.

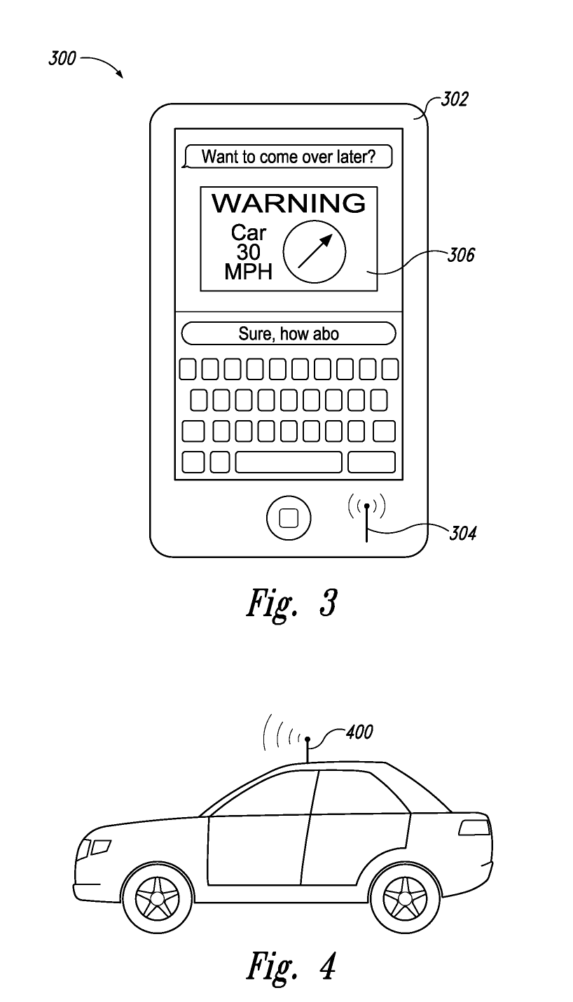

In the embodiment shown in FIG. 3, a pedestrian warning system 300 may be embodied as an “app” for a cellular telephone 302. Telephone 302 includes a radar (or lidar) detector 304 as described above, that may detect appropriately equipped cars. Modern smartphones typically include all of the other necessary apparatus for determining whether to issue an alarm and for warning a pedestrian (microprocessors, speakers, memory, transmitters, accelerometers, etc.) described above, and may be used to implement the processes already described. In addition, a smartphone may have information about the distraction level of the pedestrian. If a pedestrian is texting, for example, he is not likely to also be scanning the area for cars, but is looking at his phone and could be warned with an alert message that appears on the phone screen, a vibration, a sound, or a combination. In the embodiment shown in FIG. 3, while the phone was being used for texting, a warning box 306 shows the direction and speed of a car (not shown). In this or other embodiments, telephone 302 may also (or instead) emit an audible or haptic alarm. The details of the alarms used and the conditions under which telephone 302 will alert the user may be user-defined, either by the pedestrian or by another user (e.g., a parent).

A vehicle equipped with radar (or lidar) systems for collision avoidance or the like may include a modulator for the radar transmitter 400 designed to interact with system 100, as shown in FIG. 4. Radar transmitter 400 may continuously transmit the speed, direction, or capabilities of the vehicle so that system 100 may more accurately determine the likelihood of collision and what actions to take.

Various embodiments of pedestrian warning devices and methods have been described herein. In general, features that have been described in connection with one particular embodiment may be used in other embodiments, unless context dictates otherwise. For example, the voice alarms described in connection with FIG. 1 may be employed in the devices described in connection with FIG. 3, or with any of the embodiments described herein. For the sake of brevity, descriptions of such features have not been repeated, but will be understood to be included in the different aspects and embodiments described herein.

It will be understood that, in general, terms used herein, and especially in the appended claims, are generally intended as “open” terms (e.g., the term “including” should be interpreted as “including but not limited to,” the term “having” should be interpreted as “having at least,” the term “includes” should be interpreted as “includes but is not limited to,” etc.). It will be further understood that if a specific number of an introduced claim recitation is intended, such an intent will be explicitly recited in the claim, and in the absence of such recitation no such intent is present. For example, as an aid to understanding, the following appended claims may contain usage of introductory phrases such as “at least one” or “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a transmitter” should typically be interpreted to mean “at least one transmitter”); the same holds true for the use of definite articles used to introduce claim recitations. In addition, even if a specific number of an introduced claim recitation is explicitly recited, it will be recognized that such recitation should typically be interpreted to mean at least the recited number (e.g., the bare recitation of “two alarms,” or “a plurality of alarms,” without other modifiers, typically means at least two alarms). Furthermore, in those instances where a phrase such as “at least one of A, B, and C,” “at least one of A, B, or C,” or “an [item] selected from the group consisting of A, B, and C,” is used, in general such a construction is intended to be disjunctive (e.g., any of these phrases would include but not be limited to systems that have A alone, B alone, C alone, A and B together, A and C together, B and C together, or A, B, and C together, and may further include more than one of A, B, or C, such as A₁, A₂, and C together, A, B₁, B₂, C₁, and C₂ together, or B₁ and B₂ together). It will be further understood that virtually any disjunctive word or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A pedestrian warning device, comprising:
a radar detector configured to be worn or carried by a pedestrian and to detect vehicle-detection radar signals emanating from a vehicle; and
an alarm configured to warn the pedestrian of the vehicle.

2. The device of claim 1, wherein the alarm is audible.

3.-5. (canceled)

6. The device of claim 1, wherein the alarm is visual.

7. The device of claim 1, wherein the alarm is haptic.

8. The device of claim 12, wherein the alarm includes a command for the pedestrian.

9. (canceled)

10. The device of claim 12, wherein the alarm includes information about the vehicle.

11. (canceled)

12. The device of claim 1, further comprising a decision unit configured to determine whether to sound the alarm.

13.-14. (canceled)

15. The device of claim 1, further comprising transmission means configured to communicate to the vehicle.

16. The device of claim 15, wherein the transmission means include a radar transmitter.

17. The device of claim 15, wherein the transmission means include a lidar transmitter.

18. The device of claim 15, wherein the transmission means include a reflector.

19. The device of claim 15, wherein the transmission means include a retroreflector.

20. (canceled)

21. The device of claim 1, further comprising a recording unit configured to record at least one member of the group consisting of the signal emanating from the vehicle, the time of the signal, the location of the vehicle, the location of the pedestrian, the speed of the vehicle, the direction of the vehicle, the time-to-impact, the speed of the pedestrian, the position of the pedestrian, any alarms issued, and any reaction of the pedestrian to an issued alarm.

22. The device of claim 1, further comprising control means configured to issue a control directive to a pedestrian vehicle under control of the pedestrian.

23.-24. (canceled)

25. The device of claim 1, wherein the device is a cellular telephone.

26. The device of claim 12, wherein the device is configured to determine a characteristic of the detected radar signal.

27. The device of claim 26, wherein the determined characteristic is selected from the list consisting of direction, frequency, Doppler shifts, amplitude, and waveform.

28. The device of claim 26, wherein the determined characteristic includes informational modulation of the radar signal.

29. The device of claim 1, further comprising an accelerometer.

30. (canceled)

31. The device of claim 1, further comprising a GPS receiver.

32. The device of claim 1, further comprising a digital memory configured to store digital mapping data.

33. A pedestrian warning device, comprising:
a lidar detector configured to be worn or carried by a pedestrian and to detect vehicle-detection lidar signals emanating from a vehicle; and
an alarm configured to warn the pedestrian of the vehicle.

34.-74. (canceled)

75. A method of warning a pedestrian of a vehicle, comprising:
receiving a vehicle-detection lidar signal from the vehicle at a lidar detector configured to be worn or carried by the pedestrian; and
alerting the pedestrian with an alarm.

76. The method of claim 75, wherein alerting the pedestrian includes alerting the pedestrian with a sound.

77. The method of claim 75, wherein alerting the pedestrian includes alerting the pedestrian visually.

78. The method of claim 75, wherein alerting the pedestrian includes alerting the pedestrian haptically.

79. The method of claim 75, wherein alerting the pedestrian includes issuing a command to the pedestrian.

80. (canceled)

81. The method of claim 75, wherein alerting the pedestrian includes giving the pedestrian information about the vehicle.

82.-83. (canceled)

84. The method of claim 75, further comprising transmitting a control directive to a pedestrian vehicle under control of the pedestrian.

85. The method of claim 75, further comprising using an accelerometer to determine a response of the pedestrian to the alarm.

86. A pedestrian warning device, comprising:
a vehicle detector configured to be worn or carried by a pedestrian and to detect vehicle-detection signals emanating from a vehicle; and
an alarm configured to warn the pedestrian of the vehicle.

87. The device of claim 86, wherein the vehicle detector comprises a wide-angle camera.

88. The device of claim 86, further comprising a transmitter configured to transmit information about the pedestrian to the vehicle.

89.-93. (canceled)

94.-95. (canceled)

96. The device of claim 12, wherein the decision unit is configured to determine whether to sound the alarm based at least in part on information selected from the group consisting of the pedestrian's position, the pedestrian's orientation, the pedestrian's movement direction, the pedestrian's speed, the pedestrian's companions, the pedestrian's movement history, the vehicle's range, the vehicle's direction, the vehicle's speed, the vehicle's time to impact, and the position of a second vehicle.

97. The device of claim 12, wherein the decision unit is configured to customize the alarm based at least in part on information selected from the group consisting of the pedestrian's position, the pedestrian's orientation, the pedestrian's movement direction, the pedestrian's speed, the pedestrian's companions, the pedestrian's movement history, the vehicle's range, the vehicle's direction, the vehicle's speed, the vehicle's time to impact, and the position of a second vehicle.
